(19) United States
(12) Patent Application Publication
(10) Pub. No.: US 2005/0209740 A1
(43) Pub. Date: Sep. 22, 2005

(54) Systems and methods for controlling fans

(76) Inventor: Warren E. Vann JR., Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/805,080

(22) Filed: Mar. 19, 2004

(51) Int. Cl. G05D 23/00

(52) U.S. Cl. 700/300

(57) ABSTRACT

An assembly having a fan controller, thermal sensors, and a plurality of fans. A first device fan is located proximal to a first select electrical device. A second device fan is located proximal to a second select electrical device. A fan controller is coupled to a combination of thermal sensors located proximal to each of the first and second select electrical devices, respectively. The fan controller is coupled to the combination of thermal sensors via a thermal data channel. The fan controller adjusts the first and second device fans in accordance with information provided on the thermal data channel.

### BACKGROUND

Typically, computers have included a cooling fan inside the computer housing to prevent overheating caused by normal operation of the computer. When central processing unit clock rates were relatively low, a small fan running at a relatively low speed was sufficient to remove excess heat from the enclosure. With the increase in clock rates, it is common for many electronic enclosures to use multiple fans to maintain specified operating temperatures within the enclosures. Many CPUs have dedicated heat sinks and fans to remove heat from these integrated circuit devices.

Server computers and some personal computers include multiple CPU's. Each CPU may be provided a dedicated fan. Fan controllers are used to control the fans. Temperature data provided by sensors placed near each CPU are used by the fan controllers to adjust the speed of the respective dedicated fan. Many fan controllers adjust the speed of the dedicated fan as a function of the sensed temperature data.

Multiple channel fan controllers collect temperature data from temperature sensors strategically placed and coupled to a respective data channel. Each data channel is associated with a control channel that generates a fan control signal responsive to the measured temperature. When the measured temperature is warmer than a desired operating range for the electrical device proximal to the temperature sensor, the fan controller speeds up a fan. As the measured temperature cools, the fan controller slows the fan, thus decreasing acoustical noise. A designer might try driving multiple fans with a single control channel or using a single temperature sensor for multiple fans, to reduce system costs, both of which have disadvantages. When one control channel is used to drive dissimilar fans, the fans rotate at different speeds due to structural variations between the dissimilar fans, resulting in the loss of fan speed control and increased acoustic noise.

If designers choose to minimize fan control circuitry by reducing the number of sensors, controlled fan speeds are based on a compromise temperature somewhere in the enclosure rather than an accurate CPU operating temperature. Otherwise, fan control circuitry is duplicated for each CPU adding to the both the production and operating costs of these systems.

Consequently, improved systems and methods are desired to minimize fan control circuitry in electronic enclosures without relying on compromise temperature recordings to control fan speed.

### SUMMARY

An embodiment of a method for controlling fans comprises arranging a combination of thermal sensors, coupling the combination of thermal sensors to a thermal control channel of a controller, and controlling cooling devices in accordance with the thermal control channel.

An embodiment of an apparatus comprises a first device fan located proximal to a first select electrical device, a second device fan located proximal to a second select electrical device, a combination of a first thermal sensor and a second thermal sensor, wherein the first thermal sensor is located proximal to the first select electrical device and the second thermal sensor is located proximal to the second select electrical device, and a fan controller having a first thermal data channel coupled to the combination of the first and second thermal sensors.

An alternative embodiment of an apparatus comprises a housing having a plurality of active integrated circuit devices and a means for controlling cooling devices proximally located to select integrated circuit devices, wherein said means for controlling fans is coupled to a combination of a first thermal sensing means and a second thermal sensing means.

### BRIEF DESCRIPTION OF THE DRAWINGS

Systems and methods for controlling cooling fans or other devices are illustrated by way of example and not limited by the implementations depicted in the following drawings. The components in the drawings are not necessarily to scale. Emphasis instead is placed upon clearly illustrating the principles of the present systems and methods. Moreover, in the drawings, like reference numerals designate corresponding parts throughout the several views.

FIGS. 1A and 1B are diagrams illustrating an embodiment of an electronic enclosure.

FIGS. 2A and 2B are a functional block diagram and a perspective view illustrating an arrangement of a fan controller, device fans, and thermal sensors that can be used to control internal temperatures within the electronic enclosure of FIG. 1.

FIG. 3 is a schematic diagram illustrating an embodiment of a circuit for coupling thermal sensors.

FIGS. 4A and 4B are schematic diagrams illustrating alternative circuit embodiments for coupling thermal sensors.

FIG. 5 is a flow diagram illustrating an embodiment of a method for controlling cooling fans in the electronic closure of FIG. 1.

FIG. 6 is a flow diagram illustrating an embodiment of an alternative method for controlling cooling fans in the electronic closure of FIG. 1.

### DETAILED DESCRIPTION

Systems and methods for controlling fans or other cooling devices are described below. A controller configured to measure and respond to two remote thermal sensors via two remote data channels is coupled to a combination of remote thermal sensors on a thermal data channel.

The forward voltage of a diode or a diode-connected transistor, operated at constant current, exhibits a negative temperature coefficient, V_{be}, of about −2 mV/° C. V_{be} varies from device to device. To account for individual responses, the change in V_{be} can be determined at two or more different currents as follows.
ΔV_{be}=KT/q×ln(N) Eq. 1
where: K is Boltzmann's constant. q is charge on the carrier. T is absolute temperature in Kelvin. N is the ratio of the two currents.

To measure ΔV_{be} the controller is switched to provide operating currents of I and N×I across the pn junction of the diode or the diode-connected transistor. The resulting voltage waveform is low-pass filtered to remove noise, amplified, and rectified to produce a direct coupled (DC) voltage proportional to ΔV_{be}. The results of remote temperature measurements can be digitized and stored for application in a thermal control algorithm suited to one or more electronic devices.

Systems and methods for controlling fans or other cooling devices minimize circuitry by adding a thermal sensor in combination with a first thermal sensor on a thermal data channel of a controller. Consequently, one can control two cooling devices designated to cool similar electronic devices with a single thermal control channel. Remaining thermal control channels associated with multiple channel controllers can be used to control dissimilar cooling devices.

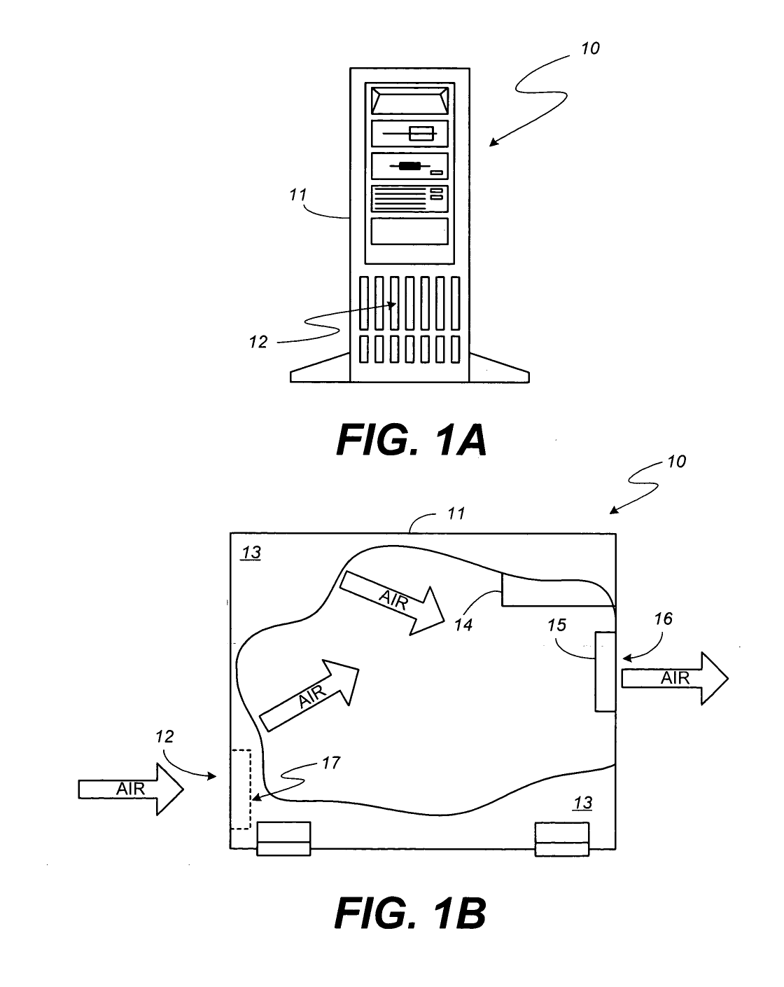

FIG. 1A presents an embodiment of an electronic enclosure 10. Specifically, the electronic enclosure 10 illustrated in FIG. 1A is a front plan view of a desktop computer housing 11 including an air inlet 12 for receiving ambient air to cool the various electrical assemblies such as the power supply and integrated circuits within computer housing 11.

FIG. 1B presents a side view with a portion of an exterior panel 13 of the computer housing 11 removed to reveal some of the components housed within the electronic enclosure 10. The computer housing 11 surrounds a power supply 14, a first enclosure fan 15 and an optional second enclosure fan 17. Power supply 14 can be supplied with a dedicated fan (not shown). First enclosure fan 15 is mounted in close proximity to air outlet 16 to draw heated air out from the computer housing 11. Optional second enclosure fan 17 is mounted in close proximity to air inlet 12. When the first enclosure fan 15 is activated, ambient air is drawn through air inlet 12 into the volume within the computer housing 11 past the various electrical assemblies and integrated circuits (not shown for ease of illustration and discussion) where it is drawn past first enclosure fan 15 and through air outlet 16 on its way out of the computer housing 16. When optional second enclosure fan 17 is provided and activated an increase in ambient airflow into the computer housing 11 results.

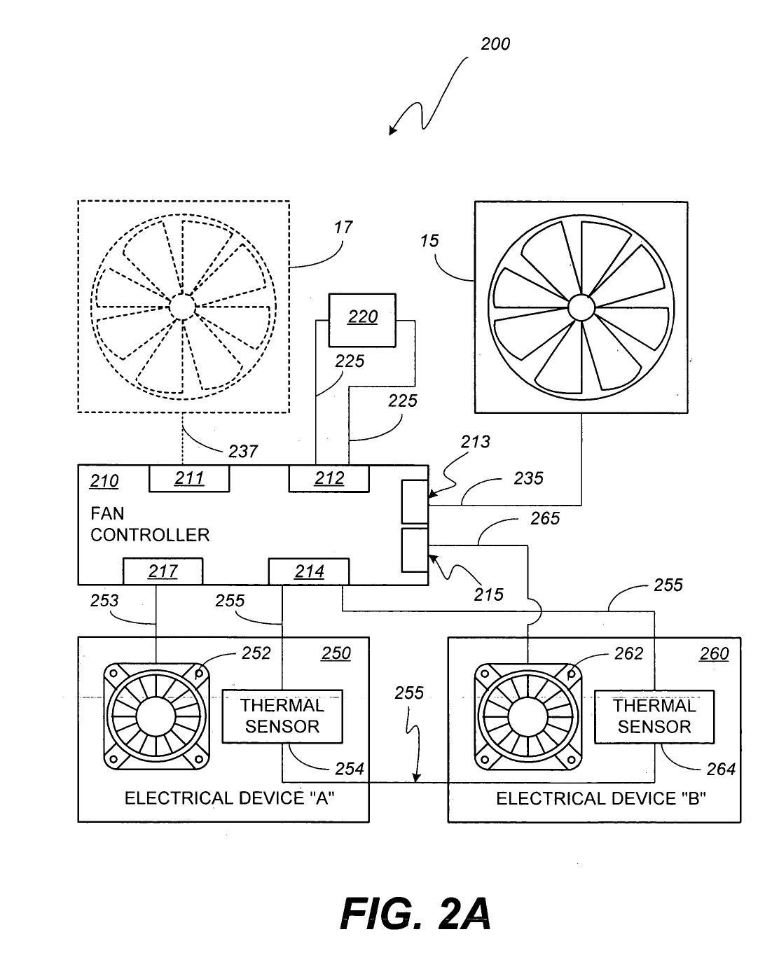

FIG. 2A is a functional block diagram that illustrates an embodiment of a multiple fan control system 200 that can be arranged within the computer housing 11 of FIGS. 1A and 1B to maintain operational temperatures of the various electrical assemblies and integrated circuits enclosed therein. In the embodiment illustrated in FIG. 2A, fan controller 210 includes fan drive channels 211, 213, 215, and 217 for providing the necessary voltage and current to controllably operate optional enclosure fan 17, first enclosure fan 15, dedicated device fan 262, and dedicated device fan 252, respectively. Fan controller 210 further includes an ambient air data channel 212 and remote data channel 214.

As illustrated in the diagram of FIG. 2A, fan controller 210 is coupled to optional enclosure fan 17 via fan drive channel 211 and harness 237. Fan controller 210 is coupled to enclosure fan 15 via fan drive channel 213 and harness 235. Fan controller 210 is coupled to dedicated device fan 252 via fan drive channel 217 and harness 253. Fan controller 210 is coupled to dedicated device fan 262 via fan drive channel 215 and harness 265. Fan controller 210 is coupled to enclosure thermal sensor 220 via thermal data channel 212 and conductor 225. Fan controller is coupled to thermal sensor 254 and thermal sensor 264 via thermal data channel 214 and conductor 255. Each of the harnesses 235, 237, 253, 265 include the necessary conductors to provide power to their respective fan. In addition, each of the harnesses 235, 237, 253, 265 may include one or more conductors to provide feedback signals to the fan controller 210. These feedback signals may include an indication of the rotational speed of the respective fan.

As is further illustrated in FIG. 2A, dedicated device fan 252 and thermal sensor 254 are located in close proximity to electrical device “A” 250. Similarly, dedicated device fan 262 and thermal sensor 264 are located in close proximity to electrical device “B” 260. Fan controller 210 supplies power to the multiple fans based on temperatures recorded via enclosure thermal sensor 220 and dedicated thermal sensors 254, 264.

Power is supplied to the various fans in accordance with a thermal operating profile associated with each of the enclosure thermal sensor 220, thermal sensor 254 and thermal sensor 264. As will be explained in further detail below, the thermal operating profile for thermal sensors 254, 264 will be the same to ensure adequate air flow to maintain electrical device “A” 250 and electrical device “B” 260 within their designated operational temperature ranges.

Fan controller 210 controllably activates and adjusts a drive signal generated within the respective fan drive channels 211, 213, 215, 217 to control the speed of fans coupled to the drive channels 211, 213, 215, 217. Each of the drive signals are provided along respective harnesses 237, 235, 253, 265 to optional enclosure fan 17, enclosure fan 15, dedicated device fan 252, and dedicated device fan 262, respectively, to control internal temperatures within the electronic enclosure of FIG. 1.

Fan controller 210 activates and controls enclosure fan 15 and optional enclosure fan 17 in accordance with a recorded temperature provided by enclosure thermal sensor 220 and an enclosure thermal operating profile. Fan controller 210 can activate one or both fans and control their respective rotational speeds to keep the ambient air temperature measured by enclosure thermal sensor 220 within a desired operating range defined by the enclosure thermal operating profile. When the measured temperature is well within the operating range, fan controller 210 may employ both acoustic noise and power conservation techniques. When the measured temperature exceeds the operating range, fan controller 210 may activate all fans at full speed to reduce the measured temperature. In addition, fan controller 210 may provide information including a warning to the operating system or some other system protection software operable within computer housing 11 or coupled to the computer. When the fan controller 210 is unable to keep the air surrounding enclosure thermal sensor 220 within the desired operating range for a select amount of time various electrical devices within the computer housing 11 may be deactivated or adjusted in some other way (e.g., reducing the frequency of a clock signal applied to a CPU) to prevent permanent damage.

Fan controller 210 can be implemented using a commercially available remote thermal controller and voltage monitor such as the ADM 1027 manufactured by Analog Devices of Norwood, Mass., U.S.A. The ADM1027 controller is a systems monitor and multiple pulse-width modulated (PWM) fan controller suitable for noise sensitive applications. The controller monitors multiple central processor unit (CPU) supply voltages and its own internal supply voltage. In addition, the controller monitors the temperature of two remote sensors and its own internal temperature. The controller measures and controls the speed of up to four fans so that they operate at the slowest possible speed to minimize acoustic noise. Once control loop parameters are programmed, the ADM 1027 varies fan speed without CPU intervention.

FIG. 2B is a perspective view illustrating an embodiment of a heat dissipation system 202. Heat dissipation system 202 includes a base 240, e.g., a mounting surface of a printed circuit board; the electrical device “A” 250, which may be plugged into a socket (not shown for simplicity of illustration); the thermal sensor 254, and dedicated device fan 252 as introduced in FIG. 2A. As illustrated in FIG. 2B, electrical device “A” 250 is an integrated circuit, e.g., an application specific integrated circuit, a microprocessor, among others. Heat sink assembly 272 is attached to the upper surface of the integrated circuit and includes a plurality of members arranged to conduct heat away from electrical device “A” 250. Dedicated device fan 252 is attached to the upper surfaces of the members of heat sink assembly 272. Harness 253 couples dedicated device fan 252 to fan drive channel 217 (FIG. 2A). Thermal sensor 254 is attached to a surface of heat sink assembly 272 (or some other suitable location near the integrated circuit or its mounting socket). Conductor 255 couples thermal sensor 254 to thermal data channel 214 (FIG. 2A).

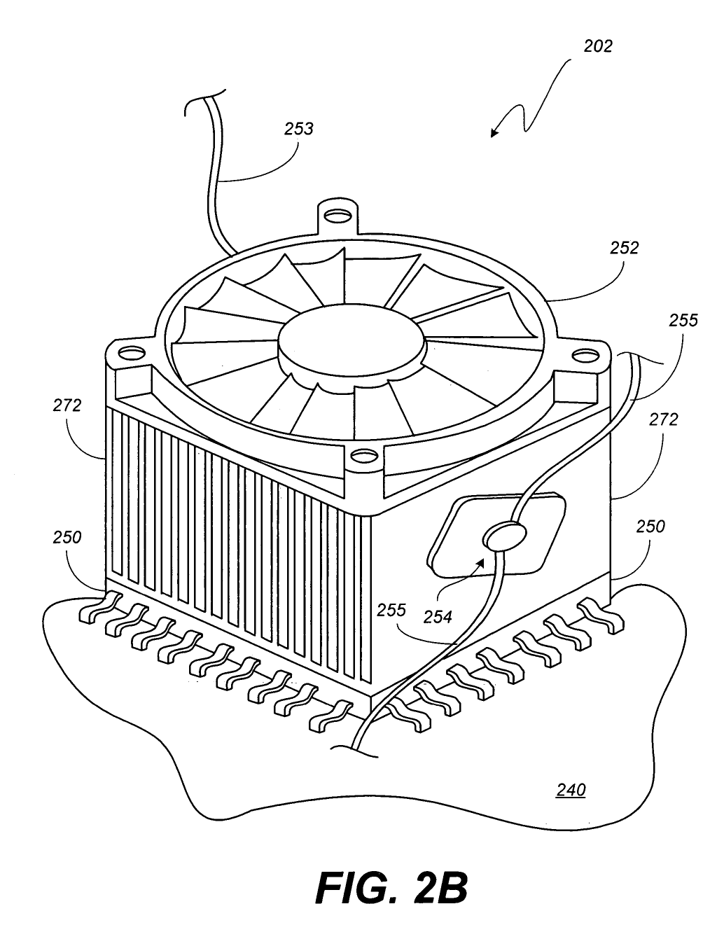

FIG. 3 is a schematic diagram illustrating an embodiment of a circuit for coupling thermal sensors. As illustrated in the schematic of FIG. 3, thermal sensors 254 and 264 are forward-biased diodes coupled in parallel via conductor 255 between the D+ and D− inputs of thermal data channel 214 of fan controller 210. Thermal data channel 214 is sensitive to changes in current through conductor 255. The total current through conductor 255, illustrated as iₜₒₜₐₗ in FIG. 3, is the sum of i₁, the current through thermal sensor 254, and i₂, the current through thermal sensor 264. When a diode heats up, the diode conducts more current, increasing iₜₒₜₐₗ. As one of the two sensing diodes heats up, the warmer sensing diode conducts more of the total current. Consequently, when there is a large temperature difference between the sensors, the thermal data channel 214 tracks the hotter of the two forward-biased diodes. This yields the desirable result that fan control is more accurate when one sensing diode is much warmer than the other sensor.

When the forward-biased diodes are the same temperature, current is shared equally between the two diodes, so little temperature error is induced. For diodes with similar responses, i.e., current draw with temperature, measurements have shown that the temperature error for the warmer of the two forward-biased diodes is less than the inherent error of the fan controller when coupled to a single sensing diode. Measurement error is expected to increase for configurations with sensing diodes with dissimilar responses to temperature, but will be still be accurate enough for many applications. For many fan controllers, temperature error is in the negative direction for the warmer diode. These fan controllers may provide the capability to compensate for the expected error by adding a fixed offset to the temperature measurement.

Thermal sensors 254 and 264 can be implemented via substrate diodes provided for temperature monitoring on some microprocessors. Alternatively, thermal sensors 254 and 264 can be implemented by any of a number of small signal diodes such as part number 1N4148 provided by Fairchild Semiconductor Corporation of South Portland, Me., U.S.A.

When thermal sensors 254 and 264 are substrate diodes on respective microprocessor substrates or discrete diodes placed in close proximity to respective microprocessors, as one of the corresponding microprocessors increases in temperature over the temperature of the other microprocessor, the corresponding thermal sensor (i.e., the diode) begins to conduct more current than the thermal sensor associated with the cooler of the two microprocessors. Because the total thermal data channel current on conductor 255 is the sum of the currents flowing in the thermal sensors, the thermal data channel 214 will respond to the warmer of the two microprocessors. Accordingly, once the temperature of the warmer of the two microprocessors exceeds a threshold value, the fan controller 210 can be configured to drive two similarly configured dedicated device fans 252, 262 until the temperature recorded by the thermal data channel 214 falls below a second threshold value.

For multiprocessor systems that share processing among the various processors and that exhibit relatively close processor temperatures under like conditions, respective thermal sensors 254, 264 associated with each of the processors can be expected to draw nearly equal amounts of the total current provided by the thermal data channel 214. Under these circumstances, the thermal data channel 214 responds when both thermal sensors 254, 264 indicate that their respective microprocessors have exceeded a threshold value. Fan controller 210 can be configured to drive dedicated device fans 252, 262 until the temperature recorded by the thermal data channel 214 falls below a second threshold value.

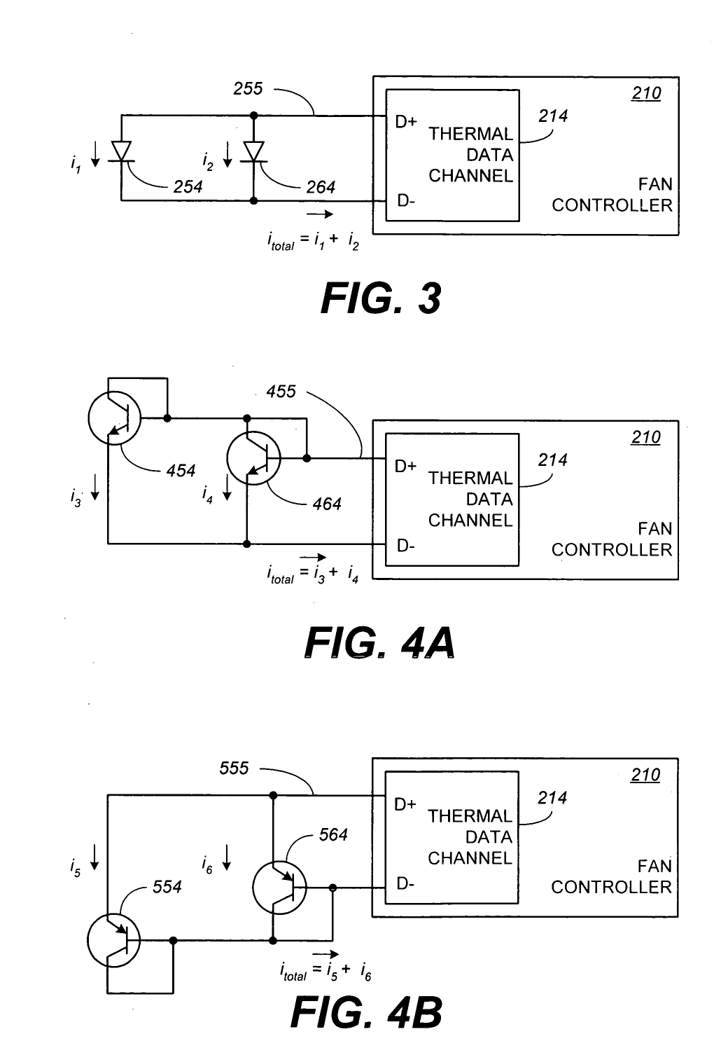

FIGS. 4A and 4B are schematic diagrams illustrating alternative circuit embodiments for coupling thermal sensors. FIG. 4A illustrates the application of NPN-type transistors 454 and 464 in place of the forward-biased diodes 254, 264 in the circuit of FIG. 3. As illustrated in the schematic of FIG. 4A, NPN-type transistors 454 and 464 are coupled in parallel via conductor 455 between the D+ and D− inputs of thermal data channel 214 of fan controller 210. The base and collector of each respective NPN-type transistor 454, 464 are coupled to the D+ input of thermal data channel 214. The emitter of each respective NPN-type transistor 454, 464 are coupled to the D− input of thermal data channel 214.

The total current through conductor 455, illustrated as iₜₒₜₐₗ in FIG. 4A, is the sum of i₃, the current through thermal sensor 454, and i₄, the current through thermal sensor 464. When a transistor heats up, the transistor conducts more current, increasing iₜₒₜₐₗ.

NPN-type transistors 454 and 464 can be implemented via a substrate transistor provided for temperature monitoring on some microprocessors. Alternatively, NPN-type transistors 454 and 464 can be implemented via discrete transistors such as part number 2N3904 provided by Fairchild Semiconductor Corporation of South Portland, Me., U.S.A.

FIG. 4B illustrates the application of PNP-type transistors 554 and 564 in place of the forward-biased diodes 254, 264 in the circuit of FIG. 3. As illustrated in the schematic of FIG. 4B, PNP-type transistors 554 and 564 are coupled in parallel via conductor 555 between the D+ and D− inputs of thermal data channel 214 of fan controller 210. The emitter of each respective PNP-type transistor 554, 564 are coupled to the D+ input of thermal data channel 214. The base and collector of each respective PNP-type transistor 554, 564 are coupled to the D− input of thermal data channel 214.

The total current through conductor 555, illustrated as iₜₒₜₐₗ in FIG. 4B, is the sum of i₅, the current through thermal sensor 554, and i₆, the current through thermal sensor 564. When a transistor heats up, the transistor conducts more current, increasing iₜₒₜₐₗ.

PNP-type transistors 554 and 564 can be implemented via a substrate transistor provided for temperature monitoring on some microprocessors. Alternatively, PNP-type transistors 554 and 564 can be implemented via discrete transistors such as part number 2N3906 provided by Fairchild Semiconductor Corporation of South Portland, Me., U.S.A.

While the NPN-type transistors 454, 464 (FIG. 4A) and PNP-type transistors 554, 564 (FIG. 4B) are connected to work like diodes, other temperature responsive circuit configurations using transistors and perhaps other semiconductor devices can be coupled in parallel to a thermal data channel of a fan controller to support the present systems and methods for controlling fans in an electronic enclosure.

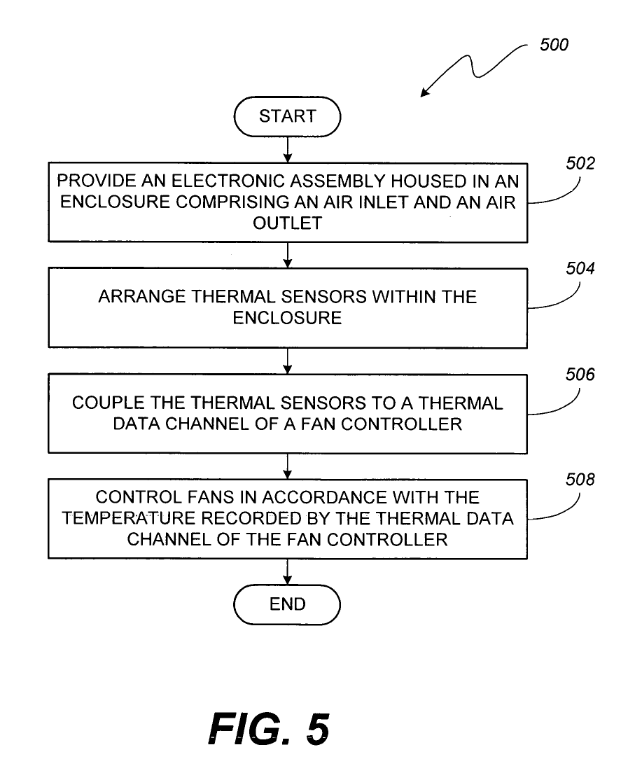

FIG. 5 is a flow diagram illustrating an embodiment of a method for controlling cooling fans in the electronic enclosure 10 of FIG. 1. Method 500 begins with block 502 where an electronic assembly is housed in an enclosure comprising an air inlet and an air outlet. As shown in block 504, thermal sensors are arranged at desired locations within the enclosure and coupled in parallel. As indicated in block 506, the parallel combination of thermal sensors is coupled to a thermal data channel of a fan controller. Then, as indicated in block 508, fans are controlled in accordance with the temperature recorded by the thermal data channel of the fan controller. When identical fans are driven by the fan controller in accordance with the temperature as indicated by the parallel combination of thermal sensors, a single three-channel fan controller can control two dedicated device fans, such as CPU fans, and two dissimilar enclosure fans without necessitating additional fan control circuitry.

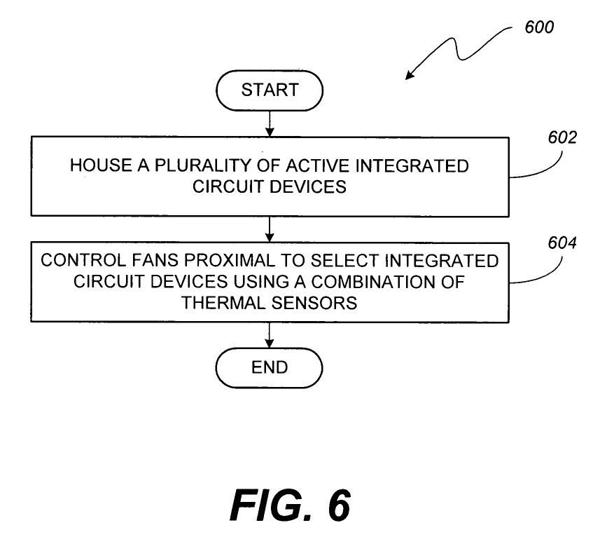

FIG. 6 is a flow diagram illustrating an embodiment of an alternative method for controlling cooling fans in the electronic enclosure 10 of FIG. 1. Method 600 begins with block 602 where a plurality of active integrated circuit devices are housed in an enclosure. Thereafter, as indicated in block 604, fans proximal to select integrated circuit devices are controlled using a parallel-coupled combination of thermal sensors.

Although illustrated embodiments of the claimed systems and methods for controlling fans in an electronic enclosure have been illustrated and described in association with a computer housing having dedicated device fans attached to conductive heat sinks to thermally protect integrated circuit devices, the present systems and methods are not so limited. For example, a parallel combination of thermal sensors can be coupled to a single thermal data channel of a controller that drives cooling devices other than fans. These alternative cooling devices include assemblies that direct or otherwise apply a medium having a temperature lower than the integrated circuit devices to be cooled at or in close proximity to the integrated circuit devices. Accordingly, other embodiments, variations, and improvements not described herein are not necessarily excluded from the systems and methods as defined by the following claims.

1. A method for controlling fans comprising:
arranging a combination of thermal sensors;
coupling the combination of thermal sensors to a thermal data channel of a controller; and
controlling cooling devices in accordance with the thermal data channel.

2. The method of claim 1, wherein arranging comprises placing the thermal sensors in proximity to electrical devices.

3. The method of claim 2, wherein the electrical devices are processors.

4. The method of claim 1, wherein the thermal sensors are coupled in parallel.

5. The method of claim 4, wherein the thermal sensors are constructed to respond uniformly to changes in temperature.

6. The method of claim 1, wherein the thermal sensors are diodes.

7. The method of claim 1, wherein the thermal sensors are transistors.

8. The method of claim 1, further comprising installing the controller and the combination of thermal sensors in an electronic enclosure.

9. An electronic assembly comprising:
means for housing a plurality of active integrated circuit devices; and
means for controlling cooling devices proximal to select integrated circuit devices, wherein said means for controlling cooling devices is coupled to a combination of a first thermal sensing means and a second thermal sensing means.

10. The electronic assembly of claim 9, wherein said means for controlling cooling devices uses a single thermal data channel to sense thermal information provided by the first and second thermal sensing means.

11. The electronic assembly of claim 9, wherein said means for controlling cooling devices drives a first cooling device located proximal to a first processor and a second cooling device located proximal to a second processor.

12. The electronic assembly of claim 11, wherein said means for controlling cooling devices drives the first and second fans in response to the warmest of the first processor and the second processor.

13. The electronic assembly of claim 9, wherein the combination of the first thermal sensing means and the second thermal sensing means is arranged in parallel.

14. An apparatus comprising:
a first device fan located proximal to a first select electrical device;
a second device fan located proximal to a second select electrical device,
a combination of a first thermal sensor and a second thermal sensor, wherein the first thermal sensor is located proximal to the first select electrical device and the second thermal sensor is located proximal to the second select electrical device; and
a fan controller having a first thermal data channel coupled to the combination of the first and second thermal sensors.

15. The apparatus of claim 14, wherein the fan controller senses the warmer of the first select electrical device and the second select electrical device and drives both the first device fan and the second device fan in accordance with a thermal operating profile for the first and second select electrical devices.

16. The apparatus of claim 15, wherein the first select electrical device and the second select electrical device comprise integrated circuits.

17. The apparatus of claim 14, wherein the first and second thermal sensors respond uniformly to changes in temperature.

18. The apparatus of claim 14, wherein the first and second thermal sensors are diodes.

19. The apparatus of claim 14, wherein the first and second thermal sensors are transistors.

20. The apparatus of claim 14, wherein the first device fan and the second device fan are substantially similar.

21. The apparatus of claim 14, further comprising:
an enclosure having an enclosure fan and a third thermal sensor coupled to a second thermal data channel of the fan controller.

22. The apparatus of claim 21, wherein the fan controller senses temperature using the third thermal sensor and the second thermal data channel and drives the enclosure fan in accordance with a thermal operating profile for the enclosure.
